(19) United States
(12) Patent Application Publication
(10) Pub. No.: US 2024/0181935 A1
(43) Pub. Date: Jun. 6, 2024

(54) METHOD FOR OPERATING A UTILITY VEHICLE WITH A FUEL CELL

(71) Applicant: ZF CV Systems Global GmbH, Bern (CH)

(72) Inventor: Janik Ricke, Uetze (DE)

(21) Appl. No.: 18/443,047

(22) Filed: Feb. 15, 2024

Related U.S. Application Data
(63) Continuation of application No. PCT/EP2022/071539, filed on Aug. 1, 2022.

(30) Foreign Application Priority Data
Aug. 16, 2021 (DE) 10 2021 121 179.4

(51) Int. Cl. B60L 58/30; H01M 8/04111; H01M 8/04858

(52) U.S. Cl. CPC B60L 58/30; H01M 8/04111; H01M 8/04932; H01M 8/04947; B60L 2240/62; B60L 2240/64; B60L 2240/662; H01M 2250/20

(57) ABSTRACT

A method is for operating a utility vehicle which has an electric motor drive, an electrical storage system for supplying the electric motor drive and a fuel cell for supplying the electrical storage system, including the steps: controlling the fuel cell during the journey in such a manner that the charge level of the electric energy storage system is below its predetermined charge level when a driving interruption occurs, and continuing to control the fuel cell during the journey interruption until the electrical storage system has reached the predetermined charge level and/or the driving interruption has ended. A fuel cell system is for the method and a control unit and computer program product implement the method.

### CROSS-REFERENCE TO RELATED APPLICATIONS

This application is a continuation application of international patent application PCT/EP2022/071539, filed Aug. 1, 2022, designating the United States and claiming priority from German application 10 2021 121 179.4, filed Aug. 16, 2021, and the entire content of both applications is incorporated herein by reference.

### TECHNICAL FIELD

The disclosure relates to a method for operating a utility vehicle which has an electric motor drive, an electrical storage system with a maximum charging capacity and a variable state of charge for supplying the electric motor drive and a fuel cell for supplying the electrical storage system.

### BACKGROUND

Utility vehicles with an electric motor and fuel cell for supplying power to the electric motor are generally known in the art. The electric motors installed in the vehicles are typically highly responsive, meaning that they can deliver very different power levels in a very short period of time. By contrast, however, a fuel cell can be operated most efficiently when it is exposed to as few dynamic load changes as possible, that is, when it can be operated as uniformly as possible at an efficient operating point. For this reason, the fuel cell is not typically directly connected to the electric motors, but rather to the electrical storage system, which acts as a buffer. The fuel cell feeds the electric energy it generates into the electrical storage system and the electric motors are supplied with the electric energy required for propulsion from the electrical storage system.

The fuel cell systems of utility vehicles of this kind are also subject to wear and degradation. In particular, the rapidly rotating mechanical parts of the fuel cell system, for example within the compressors and/or expanders, are especially susceptible to wear and degradation in this case.

### SUMMARY

It is an object of the disclosure to specify a method that allows for the greatest possible reduction in wear and degradation of the vehicle's fuel cell system.

The disclosure, for example, achieves the object on which it is based with a method which includes the steps:
controlling the fuel cell during the journey in such a manner that the state of charge of the electric energy storage system is below its predetermined charge level when a driving interruption occurs, and
continuing to control the fuel cell during the journey interruption until the energy storage system has reached the predetermined charge level and/or the driving interruption has ended and the journey is preferably continuing.

The disclosure is based on the knowledge that wear to the rapidly rotating parts of the fuel cell system occurs primarily when the fuel cell system is started up or shut down, that is, during the starting or stopping of the fuel cell system. Utility vehicles are rarely used primarily for short-distance journeys, but usually for long-distance journeys. During long-distance journeys, there are inevitably driving interruptions due to driver fatigue, the need for maintenance work and/or refueling and/or due to legal regulations. For example, Regulation (EC) 561/2006 specifies maximum daily driving times of 9 to 10 hours, with a mandatory break of at least 45 minutes after no more than 4.5 hours of continuous driving time within a single journey. Shorter driving intervals also allow for shorter breaks of 30 or 15 minutes. Every time the journey is interrupted, it was customary in the prior art for the fuel cell system to be shut down and it had to be restarted at the end of the driving interruption. Within the scope of the disclosure it has been recognized that these operations cause a particular degree of wear, while continuous operation of the fuel cell system is comparatively low on wear. The disclosure is therefore based on the knowledge that adhering to these legally required rest periods leads to wear and degradation of the fuel cell system. Consequently, the disclosure proposes to reduce wear by ensuring that the fuel cell system is not automatically shut down when the vehicle stops, but rather is kept busy with charging the electrical storage system for the entire duration of the driving interruption. In this way, the number of wear events is reduced and, accordingly, the overall wear too.

In an embodiment, the disclosure includes one or both of the steps:
compiling or providing journey information on a forthcoming journey and journey interruption information on at least one journey interruption planned during the forthcoming journey, and
determining a journey interruption energy amount that can be supplied from the fuel cell to the electrical storage system during the journey interruption. In this way, the journey planning that is already almost obligatory in fleet management is incorporated in the operating strategy of the fuel cell system: The compilation and provision of journey information can be done either through manual input or via the utility vehicle's fleet management system, which can suggest a stopping strategy to the driver after processing the route information and the driver can acknowledge or modify this strategy.

In order to determine the journey interruption energy amount that can be supplied during the journey interruption, a lower threshold value is preferably defined for the state of charge of the electrical storage system that should be reached at the start of the journey interruption and should be regulated to when operating the fuel cell during the journey. The energy amount that can be supplied during the journey interruption is then determined from the difference between the lower threshold of the state of charge and the desired predetermined state of charge of the electrical storage system, which is equal to or less than the maximum charging capacity. Unless otherwise specified, the maximum charging capacity is the nominal capacity of the electrical storage system. With this knowledge, the fuel cell can then continue to operate after the journey interruption has occurred without the need for it to be shut it down, significantly reducing the number of events that generate wear. Ideally, the charging process during the journey interruption is scheduled to continue until the journey resumes, eliminating the need to restart the fuel cell because it is already operational from before the journey was interrupted.

In an embodiment of the disclosure, the journey information includes one, several or all of the following pieces of information:
length of the journey,
duration of the journey,
calendar information, in particular information about work days or days off,
route topography,
time interval from last completed journey,
stops on the forthcoming journey, in particular loading and unloading operations for the freight on the utility vehicle.

Information on the length and duration of the journey, as well as calendar information, particularly regarding work days or days off, and also the time interval from the last completed journey are indicators used to determine a reasonable distribution of interruptions during the journey for the driver. The route topography provides additional information about which sections of the route require more or less energy, which affects the predicted amount of energy required for the respective sections of the route and therefore also the placement of the journey interruptions along the route. The time interval from the last completed journey can, in turn, influence the maximum length of the next journey segment, in turn taking into account legal regulations on mandatory rest times. Intermediate stops, which also occur independently of the driving times that must be observed, also represent potential wear events and act as journey interruptions, meaning that they can be advantageously considered as journey information. The above parameters can preferably be evaluated in a computer program and a stopping strategy, that is, the distribution of interruptions during the journey, is developed from them.

In another embodiment, the journey interruption information includes one, several or all of the following pieces of information:
position on the route where the journey interruption occurs,
start time of the journey interruption,
end time of the journey interruption,
duration of the journey interruption,
time interval and/or distance between adjacent journey interruptions.

The journey interruption energy amount can preferably be defined as a function of the journey interruption information, in particular as a function of the duration of the journey interruption and the power that the fuel cell can provide at a predetermined operating point.

In another embodiment, compiling the journey interruption information involves one, several or all of the following, preferably via a data query from an internal or external vehicle database, in particular a fleet management system or a tachograph, or via manual data entry:
determining the duration of a forthcoming journey,
determining the distance remaining after the next journey interruption,
determining the mass of the freight loaded onto the vehicle,
determining information that is representative of the driving behavior of the driving staff, in particular average energy consumption,
determining the presence of a trailer attached to the utility vehicle for the forthcoming journey,
determining weather data for the duration of the forthcoming journey, in particular along the route.

The disclosure takes advantage of the fact that a plurality of information is already available in the fleet management system of the utility vehicle for route planning and the operation of various vehicle systems. For example, it is possible to access the entire route plan from the fleet management system. If, for example, the driving staff are required to take a break after a forecast maximum driving time has been exceeded, but would then only be allowed to drive for another 30 minutes or if there are only 30 minutes left until the destination is reached, the fuel cell system can be turned off immediately and can remain off after the journey interruption.

The fleet management system can also advantageously determine the mass of the freight, independently of the use of any vehicle sensors, because each item of freight that is part of the load is recorded in the fleet management system with a mass.

Data regarding the driving style of the driving staff, such as average energy consumption, is also stored in the fleet management system.

Determining whether a trailer is connected, or is to be connected, is also preferably determined as journey interruption information from the fleet management system. The same applies to swap bodies loaded onto a trailer. This makes it possible to determine not only the current, but also the future, mass of the utility vehicle.

Determining weather data allows for the inclusion of road conditions, bad weather conditions and/or temperature trends in the planning of journey interruptions within the framework of forecasting accuracy. For example, during a journey interruption at temperatures below freezing, continued operation of the fuel cell system means that the problem of freezing water can be selectively reduced and/or the charging rate of the electrical storage system can be adapted to the temperature at the location and time of the journey interruption and the charging behavior and the duration of the journey interruption can therefore be adapted to one another depending on the weather conditions.

In another embodiment, compiling the journey interruption information involves one, several or all of the following:
determining a required journey interruption duration as a function of the determined journey duration and
compiling a journey interruption plan, in which the journey interruption duration is distributed over a number of journey interruptions throughout the duration of the journey, preferably evenly,
modifying and/or confirming the compiled journey interruption plan via user input.

The fuel cell can preferably be controlled as a function of the journey interruption plan.

In another embodiment, the fuel cell is configured to be operated at different operating points and the method further includes the step:
adjusting the operating point of the fuel cell during the journey interruption depending on the journey interruption information, in particular depending on the duration of the journey interruption. By adjusting the operating point of the fuel cell, the amount of charge supplied to the electrical storage system during the journey interruption can be regulated within certain limits, so that the journey interruption is fully utilized for the charging process, without the fuel cell completely filling the electrical storage system before the journey interruption has ended.

In various embodiments, the operating point of the fuel cell is adjusted in such a manner that the fuel cell continues to be controlled throughout the entire journey interruption, preferably in a range of 10% to 70% of the rated power of the fuel cell, wherein preferably 15% to 60% of the rated power of the fuel cell, particularly preferably 20% to 50% of the rated power of the fuel cell.

In another embodiment, the fuel cell has at least one compressor that has a rotationally driven compressor shaft, and the method further includes the step:
continuing to drive the compressor shaft at a predetermined speed, preferably above the lift-off speed, even if the predetermined charge level of the electrical storage system has been reached before the journey interruption has ended. It has been recognized that of the components of the fuel cell system, the bearings of the compressor assemblies, in particular, are susceptible to wear. Even when air bearings are used, wear occurs, particularly during the start-up and shutdown procedures of the fuel cell, specifically when the take-off speed of the respective bearings is undershot and the bearing components slide against each other.

The operating strategy according to the disclosure prevents the compressor shaft from coming to a standstill by continuing the operation of the fuel cell system. However, in various embodiments, it may be the case, for example, during very long journey interruptions, that the fuel cell system cannot be operated at a reasonable operating point throughout the entire journey interruption but must end the charging process at a point in time when the journey interruption is not yet over. In this case, it is particularly preferable to shut down the fuel cell while continuing to drive the compressor rotationally, in order to avoid contact of the compressor shaft. The method then preferably further includes guiding the fluid flow generated by the compressor into the environment via a bypass. In this way, it is possible to avoid the need for the compressed air that is not then immediately required to flow through the remaining system components.

In various embodiments, the control of the fuel cell during the journey is carried out in such a manner that a smaller amount of energy is provided, either continuously or in sections, during the journey than is requested by the electric motor of the vehicle, meaning that the remaining amount of energy required is supplied to the electric motor from the electrical storage system, resulting in a drop in the charge level (L). By continuously “under-supplying” the electrical storage system, the full power potential of the fuel cell is not utilized at any point in time, but instead the fuel cell is operated very consistently at the same operating point. With a view to managing the charging cycles of the energy storage system, it may be advantageous to keep the energy storage system at a constant state of charge over time intervals during the journey, in order to increase the life of the electrical storage system. It is therefore provided in a variant that the fuel cell is intermittently controlled to provide such an amount of energy that the electrical storage system is maintained at a substantially constant energy level, for example at the level of its predetermined state of charge, and that only when the next journey interruption is approaching is the fuel cell controlled to provide a lower amount of energy, and from that point, the state of charge of the electrical storage system is selectively lowered.

In embodiments in which controlling the fuel cell is executed in such a manner that a smaller amount of energy than that requested by the electric motor is only provided in sections during the journey, the point in time at which the fuel cell provides a smaller amount of energy is preferably determined as a function of one, several or all of the following parameters:
falling below a predetermined travel time remaining until the next journey interruption,
falling below a predetermined distance remaining until the next journey interruption,
the topography of the route remaining until the next journey interruption.

The desired lower charging threshold of the electrical storage system at the start of the journey interruptions is preferably the threshold also used for determining the journey interruption energy amount. If the maximum discrepancy, which is limited between the energy requirement requested by the electric motor and the minimum amount of electrical energy that can be provided by the fuel cell, which will practically be the case in most instances, this means that a maximum discharge rate for the electrical storage system during the journey is defined. By using the desired lower charging threshold, the latest point in time at which discharging must begin can be defined, so that when the journey interruption is reached, the electrical storage system has been discharged far enough to allow charging with a desired operating point of the fuel cell to be carried out over the entire duration of the journey interruption.

In various embodiments, the desired lower charging threshold of the electrical storage system is around 15% of the maximum charging capacity, or above, preferably around 20% or above, particularly preferably around 33% or above. This prevents unintentional deep discharging of the electrical storage system and keeps wear to the electrical storage system within limits.

In various embodiments, the desired lower charging threshold is determined as a function of the maximum capacity Cₘₐₓ and a maximum charging rate C=Iₘₐₓ/Cₘₐₓ of the electrical storage system, wherein C is preferably in a range of 1.5C or slower, more preferably 2C or slower. The charging rate C has units of 1/time, usually 1/hour. During charging, C represents the reciprocal of the time required to charge the rated capacity. For example, a charging rate of 2C therefore means that the electrical storage system should be charged from empty to full within a minimum of 2 hours. From this, the maximum permitted charging current can be derived: An electrical storage system with a maximum capacity Cₘₐₓ of 10,000 mAh and a charging rate of 2C could therefore be charged from empty to full within two hours with a maximum charging current of Iₘₐₓ=5 A.

It may be advantageous to throttle the energy output of the fuel cell only at a specific point in time before reaching the next journey interruption, for example when there is a predetermined residual travel time of one hour or less. Alternatively or in addition, it may be advantageous to control the fuel cell in such a manner that it automatically begins by providing a smaller amount of energy than requested when the utility vehicle reaches a certain distance from the point of the next journey interruption, for example when a predetermined residual distance to the next journey interruption is 80 kilometers or less. The topography of the route remaining until the next journey interruption can be advantageously included in determining the timing, insofar as less drive power is required during downhill stretches, on the one hand, and the electrical storage system can also be replenished through recuperation modes, on the other. On a longer downhill stretch, it is often not possible to extract as much energy from the electrical storage system as would be the case on flat terrain or uphill sections. For example, if the next journey interruption is shortly after a longish downhill stretch, the timing for initiating deliberate discharge of the electrical storage system during the journey can be brought forward. If the next journey interruption is at the end of a longish uphill stretch or shortly thereafter, the timing for initiating deliberate discharge by shutting down the fuel cell can be pushed back.

The predetermined state of charge of the electrical storage system described above at various points is understood to mean the state of charge at which the electrical storage system should have its state of charge during normal operation. This will typically not be at 100% of the maximum charging capacity, but rather below it, in order to protect the electrical storage system and to have a certain buffer available for upward adjustments, for instance in case electrical energy needs to be transferred into the electrical storage system through recuperation or other operating conditions. The predetermined state of charge of the electrical storage system is preferably below the maximum charging capacity, more preferably in a range from 50% to 80%, particularly in a range of 60-70% of the maximum charging capacity.

The disclosure has been described above with reference to the method according to the disclosure in a first aspect. In a second aspect, the disclosure relates to a fuel cell system of a utility vehicle that has an electric motor drive, with an electrical storage system, with a maximum charging capacity in a variable state of charge for supplying the electric motor drive, a fuel cell for supplying the electrical storage system and a control unit that is connected to the fuel cell in a signal-conducting manner and is configured to control the fuel cell.

The disclosure achieves the aforementioned object on which it is based in a fuel cell system of this kind, in that the control unit is configured to execute the method according to any one of the embodiments described above.

The fuel cell system according to the second aspect of the disclosure utilizes the same advantages as the method according to the first aspect. The embodiments of the method according to the disclosure are therefore simultaneously the embodiments of the fuel cell system according to the second aspect, and vice versa. To avoid repetition, reference is made to the above embodiments in this respect.

The fuel cell system preferably includes at least one compressor which has a rotationally driven compressor shaft, wherein the control unit is configured to continue driving the compressor shaft at a predetermined speed, preferably above the lift-off speed, even if the predetermined state of charge of the electrical storage system has been reached before the journey interruption has ended.

In a further aspect, the disclosure also relates to a control unit for a fuel cell system of a utility vehicle, in particular for a fuel cell system according to one of the embodiments described above.

The disclosure achieves the object referred to above with this control unit, in that the control unit is configured to execute the method according to any one of the embodiments described above.

The control unit is configured to be connected to the fuel cell system in a signal-conducting manner and has, for example, a data memory in which the commands and, if necessary, control parameters for executing the method of the embodiments described above are stored or can be connected in a data-conducting manner to a data memory of this kind, and also preferably includes a processor that is configured to execute the method according to one of the embodiments described above via the commands stored in the data memory.

The control unit also utilizes the same advantages as the method according to the disclosure and the fuel cell system according to the disclosure. Embodiments of the method and the fuel cell system are therefore also embodiments of the control unit, and vice versa. To avoid repetition, reference is made to the above embodiments in this respect.

In a further aspect, the disclosure relates to a computer program product containing commands which, when executed on a computer, cause the computer to form a control unit.

The disclosure achieves the object referred to above in relation to the computer program product, in that the commands causing a control unit to be formed according to one of the embodiments described above and/or the method is executed according to one of the embodiments described above.

### BRIEF DESCRIPTION OF DRAWINGS

The invention will now be described with reference to the drawings wherein:

FIG. 1 shows a schematic representation of a utility vehicle according to an embodiment;

FIG. 2 shows a schematic representation of a method for operating the utility vehicle according to FIG. 1; and,

FIGS. 3A, 3B and 3C show time sequence diagrams of the variable state of charge of the energy storage system of the utility vehicle.

### DETAILED DESCRIPTION

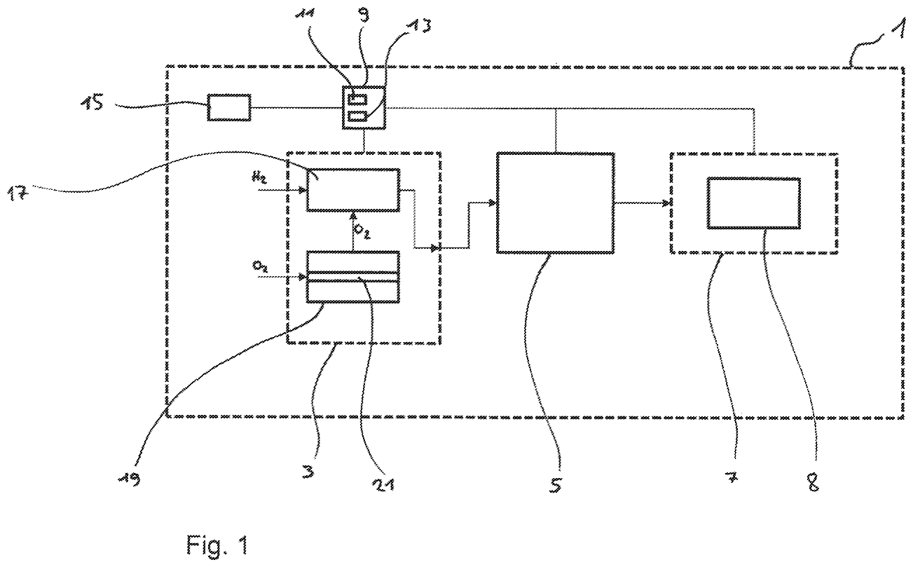

A utility vehicle 1 is schematically represented in FIG. 1. The representation is limited to the components that are essential to the disclosure, wherein it should be understood that apart from the components shown the utility vehicle may have additional components necessary for operation, such as a braking system, et cetera, for example. The depiction of elements of this kind has been omitted in order to achieve a concise representation.

The utility vehicle 1 has a fuel cell system 3 that is configured for this purpose and is connected in an energy-transferring manner to an electrical storage system 5 which has a maximum charging capacity of 120 kWh, for example, and is configured to be maintained at a predetermined charge level of 90 kWh during normal operation. The fuel cell system 3 has a rated power of 300 kW with an efficiency of 40%, for example.

The electrical storage system 5 is connected for energy transfer and is configured accordingly for the purpose of supplying electrical energy to the electric motor drive 7. The electric motor drive 7 includes one or multiple electric motors 8 which are connected accordingly to the vehicle's drivetrain, in order to convert the electrical energy supplied into propulsion.

The utility vehicle 1 has a control unit 9. The control unit 9 preferably has a data memory 11 or an interface (not shown) to a data memory of this kind, and a processor 13. The control unit 9 is connected to the fuel cell system 3 in a signal-conducting manner and is configured to control the fuel cell 17 of the fuel cell system 3 and the compressor 19 of the fuel cell system 3 to generate electrical energy.

The control unit may be a dedicated control unit or may be associated with another structural unit in terms of hardware or software, for example the fuel cell system 3, such as part of the fuel cell control or as part of the compressor control. However, the control unit 9 may also be integrated into a control unit of the utility vehicle, such as the brake control unit of the utility vehicle, for example.

The compressor 19 is configured to draw in air (02), compress it and supply it to the cathode side of the fuel cell 17. The symbol O₂ is used as the reference sign for the processed air, even though it should be understood that the supplied air need not be pure oxygen but rather a gas mixture that includes other constituents in addition to oxygen, such as nitrogen, noble gases and other constituents. The air that is used can, for example, be ambient air.

Hydrogen (H₂) is supplied to the anode side of the fuel cell and electrical energy is generated through the fuel cell reaction, which is then supplied to the electrical storage system 5.

The control unit 9 is configured to control the fuel cell system 3 in such a manner that the method is executed according to the embodiments described above. The control unit 9 is preferably connected to a fleet management system 15 of the utility vehicle 1 or is configured to receive journey information and/or journey interruption information from the fleet management system.

Commands are stored in the data memory 11 of the control unit, which, when executed, execute the method according to the disclosure, as further described in greater detail below. The processor 13 is responsible for executing the commands.

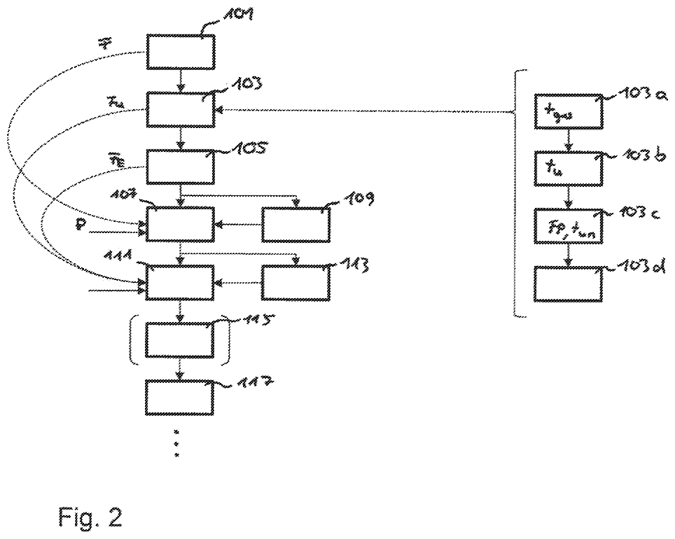

The operation of the utility vehicle using the method according to the disclosure is explained in greater detail with reference to FIG. 2. If the utility vehicle is to be operated according to the inventive method, journey information F on the forthcoming journey is provided or compiled in a process step 101, for example containing: length of the journey, duration of the journey, calendar information, in particular, information about work days or days off, route topography and/or time interval from the last completed journey. Furthermore, journey interruption information F_{U} is compiled or provided for at least one of the forthcoming journey interruptions during the forthcoming journey in a step 103, containing, for example, the position on the route where the journey interruption occurs, the start time of the journey interruption, the end time of the journey interruption, the duration of the journey interruption, the time interval, and/or distance between adjacent journey interruptions.

Having knowledge of the one or more planned journey interruptions, it is possible to determine a journey interruption energy amount F_{E} in a step 105, wherein the journey interruption energy amount F_{E} represents the amount of energy that can be provided to the electrical storage system 5 by the fuel cell 3 during the journey interruption or journey interruptions. For example, if one assumes that the goal is to operate the fuel cell at a reasonable level of efficiency of around 30% of its rated power, for example, during the journey interruption, and if the journey interruption is to last 45 minutes, the journey interruption energy amount of the fuel cell 17, which has a rated power of 300 kW, would be approximately 70 kWh.

If the journey interruption energy amount F_{E} is known, it is also possible to determine, in addition, how much the electrical storage system 5 should be discharged at the start of the journey interruption, so that the electrical storage system 5 reaches its predetermined charge level again by the end of the journey interruption, without the need to shut down the fuel cell system 3.

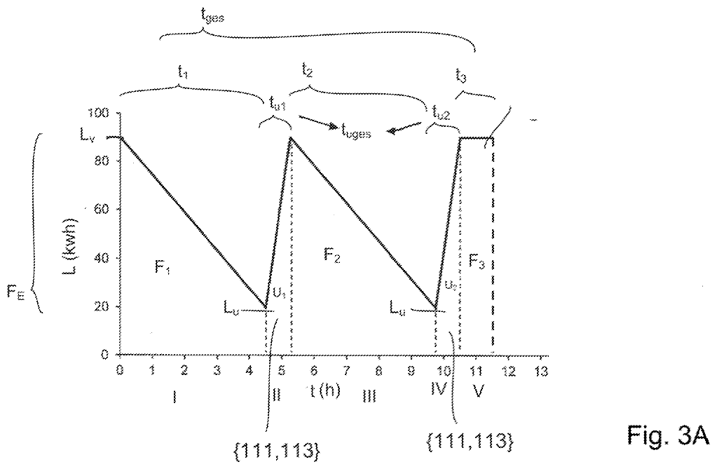

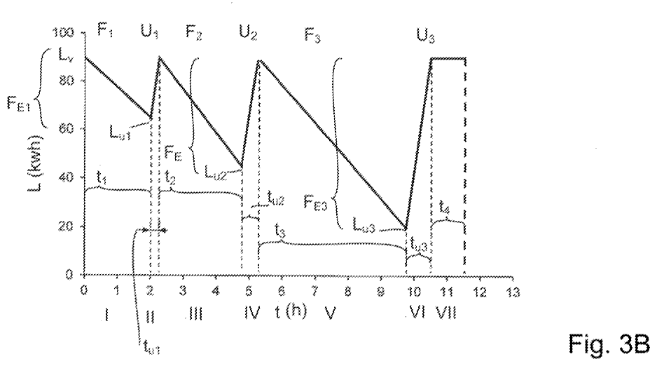

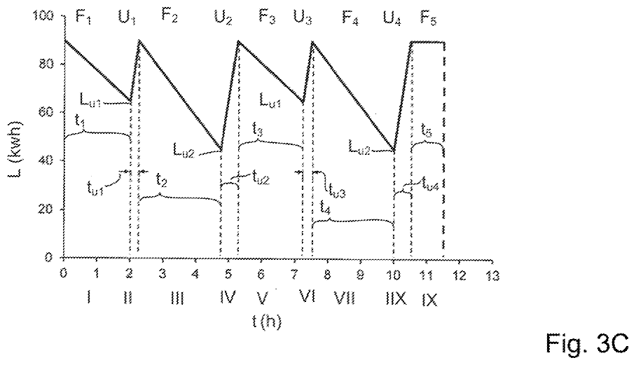

If the duration of the journey interruption is short, the power output of the fuel cell 17 can be increased within the limits of reasonable operating points. If the journey interruption is longer, the power output of the fuel cell 17 can be reduced within those limits. In a process step 107, after determining the journey interruptions, the fuel cell is controlled to operate the utility vehicle 1 and supplies electrical energy to the electrical storage system 5. It does so either in such a manner that the electrical storage system 5 is permanently supplied with a small amount of energy from the fuel cell 17, as the electric motor 8 draws it—see the diagrams in FIGS. 3A to 3C—or the fuel cell 17 is initially controlled in such a manner that the charge level of the electrical storage system is kept constant at the predetermined charge level L_{V}, and only as the journey interruption approaches is the power of the fuel cell 17 reduced so that the charge level of the electrical storage system 5 drops to a desired lower threshold L_{U} at the beginning of the journey interruption.

Reducing the power output from the fuel cell 17 is achieved in a step 109, for example, by adjusting the operating point of the fuel cell 17. The point of time at which the operating point is adjusted during the journey, in other words during step 107, is preferably determined as a function of one, several or all of the following parameters P: falling below a predetermined travel time remaining until the next journey interruption, falling below a predetermined distance remaining until the next journey interruption, route topography of the route remaining until the next journey interruption.

When the event of the journey interruption occurs, the utility vehicle 1 is parked at the location of the journey interruption in a step 111, but the fuel cell 17 continues to be controlled, as a result of which the charge level of the electrical storage system 5 starts rising again. For this purpose too, the operating point of the fuel cell 17 is optionally adjusted in a step 113, so that the journey interruption energy amount F_{E} is supplied over the duration of the journey interruption, so that the compressor shaft 21 of the compressor 19 is operated above its lift-off speed throughout the entire journey interruption, and wear in this respect is almost completely avoided.

The operation of the fuel cell 17 during steps 107 and 111 is preferably a function of the journey information F and journey interruption information F_{U}, wherein the compilation of the journey interruption information F_{U} preferably includes a subroutine with the following steps: In a step 103a, a total duration t_{ges} of the forthcoming journey is determined, preferably via a database query from an on-board or off-board vehicle database, in particular from a fleet management system 15 of the utility vehicle 1, or a tachograph (not shown), or via manual data entry. In a process step 103b, a required journey interruption duration t_{U, ges} is determined as a function of the journey duration that is determined. The journey interruption duration t_{U, ges} can preferably be obtained from a lookup table.

In a step 103c, a journey interruption plan F_{P} is compiled in which the journey interruption duration t_{U, ges} is distributed over a number of journey interruptions t_{Un} throughout the duration of the journey, preferably evenly. The journey interruption plan F_{P} is displayed to the driver of the utility vehicle 1, preferably on a graphical display or graphical user interface. In a step 103d, the journey interruption plan F_{P} is selectively modified and/or confirmed by the driver of the utility vehicle 1 via a user input, and then provided to the process as journey interruption information.

The charging process in step 111 can be scaled within the physical limits defined by the fuel cell 17 and the electric storage 5 and within reasonable operating ranges for certain durations of the trip interruption, in such a manner that the charging process extends over the entire duration of the journey interruption. With particularly long journey interruptions, however, a situation will arise in which the charging process has to be ended before the journey interruption is complete. In a case such as this, it is optionally possible in a step 115 for the fuel cell 17 to be shut down, but for the compressor shaft 19 of the compressor 21 to continue to be driven. The compressed air O₂ can be diverted, for example, via a bypass that is not shown in greater detail here. This allows for the avoidance of wear to the bearings of the compressor shaft 21 of the compressor 19, despite the shutdown of the fuel cell 17. Depending on the energy consumption for driving the compressor shaft 21, this process can be continued until the journey interruption is over and the utility vehicle 1 resumes its journey in a step 117, either to the destination or to the next journey interruption, wherein the process steps 107ff would then be executed again from step 117.

FIGS. 3A, 3B and 3C explain by way of example various journeys undertaken by the utility vehicle according to FIG. 1 using the method according to the disclosure. A first journey is shown in FIG. 3A. For this journey, a total journey time t_{ges} to be covered of 10 hours is provided as journey information F. The 10-hour journey time results in a journey interruption duration t_{U, ges} of 1.5 hours. The journey interruption duration is divided into two individual journey interruptions t_{U1}, t_{U2}=0.75 hours. The first journey is configured so that the longest possible uninterrupted journey distances can be covered in each case. Therefore, the timing of the first journey interruption is set after a journey time t₁ of 4.5 hours. The second journey interruption time is, in turn, set at the end of an uninterrupted journey time t₂=t₁ of 4.5 hours. The journey is therefore made up of three travel segments F₁, F₂, F₃ and two journey interruptions U₁, U₂. After starting the fuel cell system 3 and compiling or providing the corresponding journey information, journey interruption information and, where necessary, determining the journey interruption energy amount for the journey interruptions U₁, U₂, steps 107, 109 of the method are performed in a time segment I in the travel segment F₁ for the duration t₁: The fuel cell 17 supplies less energy to the electrical storage system 5 than the electric motor 8 requires, causing the charge level, which is plotted against time in FIG. 3A, to drop continuously from the predetermined charge level L_{V} (90 kWh) to the lower threshold L_{U}. The lower threshold L_{U} in this case corresponds to the charge level that differs from the predetermined charge level by the journey interruption energy amount F_{E} during the journey interruption U₁ in time segment II. In that time segment II, the electric motor 8 of the utility vehicle 1 is switched off and the fuel cell 17 supplies energy to the electrical storage system 5. This involves performing process step 111, optionally 113. The electrical storage system 5 reaches its predetermined charge level L_{V} again just in time as the journey interruption U₁ ends and the vehicle continues its journey towards the destination in time segment III. After t₂, another journey interruption U₂ in time segment IV is performed. At the time of the transition to time segment IV, the electrical storage system 5 has dropped again to the predetermined threshold L_{U}, and the duration t_{U2} of the journey interruption U₂ in time segment IV is once again used entirely to recharge the electrical storage system 5 to the predetermined charge level L_{V}. In the present embodiment according to FIG. 3A, the lower threshold is 20 kWh, the duration t_{U1}, t_{U2} of the journey interruption U₁, U₂ is 0.75 hours each and the journey interruption energy amount is, accordingly, 70 kWh. A fuel cell with a rated power of 300 kW could efficiently perform this charging process with an efficiency of 30%. In the final time segment V, the utility vehicle 1 continues its journey. The fuel cell is controlled, wherein unlike time segments I and III, however, the charge level does not need to be lowered because the final destination of the journey has been reached by the end of time segment V.

The method according to the disclosure can also be used with other break strategies, such as those shown in FIG. 3B, for example. In the journey according to FIG. 3B, the journey information, in the form of the total journey duration, is also 10 hours, and the necessary journey interruption duration resulting from this is also 1.5 hours, as in FIG. 3A. In this case, an alternative break strategy has been chosen, either by computer suggestion or user input, namely four travel segments F₁-F₄ with durations t₁-t₄ and three journey interruptions t_{U1}-t_{U3} with durations t_{U1}-t_{U4}. This results in a different duration for the journey interruptions in each case and therefore also a slightly different charging strategy. In a time segment I, the electrical storage system 5 is reduced to a first lower threshold L_{U1} in process step 107, 109. Since the first journey interruption U₁ only has a duration t_{U1} of 0.25 hours, the journey interruption energy amount F_{E1} is smaller than in the journey interruptions according to FIG. 3A. The charge level L_{U1} at the beginning of the first journey interruption in time segment II is therefore comparatively high at just over 60 kWh. In any case, however, this makes it possible to raise the charge level back to the predetermined charge level L_{V} within the short journey interruptions in time segment II, allowing the journey to continue without shutting down the fuel cell system 3. In time segment III, the fuel cell 17 is then again controlled in a process according to step 107 in such a manner that the electrical storage system 5 is gradually depleted. However, the second journey interruption U₂ is twice as long as the first journey interruption U₁, standing at t_{U2}=0.5 hours, allowing a larger amount of energy to be supplied in the available journey interruption duration t_{U2}. The journey interruption energy amount F_{E2} is correspondingly higher, so that the lower threshold Luz drops further at the beginning of the time segment IV to somewhat over 40 kWh in the present case. Therefore, in the time segment IV, it is also possible to fully utilize the duration t_{U2} of the journey interruption U₂ to recharge the electrical storage system 5 to the predetermined charge level L_{V} before the journey can be continued in the fifth time segment V. In the fifth time segment V, which lasts for 4.5 hours, the electrical storage system 5 is also gradually discharged again to a lower threshold L_{U3} which, in turn adapted to the duration of the journey interruption in time segment VI, is lower than the thresholds L_{U1} and Luz. In time segment VI, which has a duration t_{U3} of 0.75 hours, a total of approximately 70 kWh can be added until the predetermined charge level L_{V} is in turn reached at the end of the journey interruption, so that in the final journey segment VII the utility vehicle 1 can continue its journey to the destination with a constant charge level.

In a third journey according to FIG. 3C, in turn a journey interruption duration of 1.5 hours is assumed for a total journey duration of 10 hours, which journey interruption duration, according to FIG. 3C, is not distributed over two or three journey interruptions, as in FIG. 3A or 3B, but over five travel segments F₁-F₅ and four journey interruptions U₁ to U₄. Accordingly, the individual journey interruptions U₁ to U₄ may turn out to be shorter.

A first travel segment I has a travel duration t₁ of 2 hours, followed by a second time segment II with a journey interruption duration t_{U1} of 0.25 hours. This is followed by a time segment Ill with a travel duration t₂ of 2.5 hours, followed by a journey interruption t_{U2} in a time segment IV with a duration of 0.5 hours. This is followed by another two-hour journey t₃, F₃ in a time segment V, in turn followed by a journey interruption U₃ with a length of t_{U3} of 0.25 hours in a time segment VI. This is followed by another journey F₄ of t₄=2.5 hours duration in a time segment VII, followed by a 0.5-hour (t_{U4}) journey interruption U₄ in an eighth time segment VIII and a journey F₅ where T₅=1 hour to the destination in a final time segment IX.

In the first time segment I, according to step 107, the electrical storage system 5 is slowly discharged during the journey F₁ by controlling the fuel cell 17 accordingly for t₁ until a lower threshold L_{U1} of the charge level of the electrical storage system 5, adapted to the duration t_{U1} of the journey interruption U₁ in time segment II, is reached. The threshold L_{U1} in FIG. 3C is approximately 65 kWh. In the journey interruptions U₁ and U₂, as in the previous journeys, the electrical storage system 5 is charged to L_{V} during the times t_{U1}, t_{U2}, and in the travel segments F₁ and F₂ it has been previously discharged accordingly during the times t₁, t₂. The lower threshold Luz at the end of time segment III is around L_{U2}=45 kWh. The pattern of time segments I to IV is repeated accordingly in time segments V to VIII for the travel segments F₃, t₃, and F₄, t₄. In the final journey segment IX, the utility vehicle 1 can continue its journey F₅ for time t₅ with a constant charge level L_{V} until reaching the destination.

What the journeys in FIGS. 3A to 3C have in common is that the fuel cell system 3 can basically be operated throughout the entire time t_{ges}+t_{U, ges} without the compressor shaft 21 of the compressor 19 having to stop a single time. The wear for a journey of this time is significantly reduced, as in the sample journey in FIG. 3A, a total of two shutdown and two start-up processes of the fuel cell system 3 can be avoided. In the sample journey in FIG. 3B, there are six such wear processes, and in the sample journey in FIG. 3C, there are even eight such wear processes that can be avoided. The disclosure therefore leverages its advantage to a greater extent, the more journey interruptions are necessary during a journey. Consequently, the disclosure is also more effective the longer it is used over the operating life of a vehicle, as the number of “avoided” wear events accumulates.

FIGS. 3A to 3C show an operation in each case, in which the fuel cell supplies less energy throughout the entire journey than the electric motor 8 requires for operation. In a preferred variant (not shown), the electric motor can be kept constant, at least during longer sections of the journey, such as the sections in the time segments I and III according to FIG. 3A, for example, or in time segment V according to FIG. 3B, initially for a period of 2-3 hours, for example, in that the fuel cell 17 provides the energy requested by the electric motor. This was represented by a horizontal line in the diagrams. Only in the final part of each respective time segment before the anticipated journey interruption would a discharge then occur, represented by a correspondingly steeply declining line in the diagram.

It should be understood that in addition to the sample journeys shown by way of example, other charging strategies and journey interruption strategies can also be applied. The journey interruption strategies can also change depending on the location of the journey—especially the operation of the utility vehicle in multiple jurisdictions—and depending on the legal regulations prevailing in each case. In some cases, travel time rules, including maximum driving times and required rest breaks, differ significantly internationally. Corresponding database information is therefore preferably provided in the data memory 11 of the control unit 9 for different local positions of the utility vehicle 1 or, if necessary, loaded into the control unit 9.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Utility vehicle
3 Fuel cell system
5 Electrical storage system
7 Electric motor drive
8 Electric motor
9 Control unit
11 Data storage
13 Processor
15 Fleet management system
17 Fuel cell
19 Compressor
21 Compressor shaft
101, 103, 103a, 103b, 103c, 103d, 105, 107, 109, 111, 113, 115, 117 Process steps
O₂ Air
H₂ Hydrogen
Lₙ Charge level
F Journey information
F_{U} Journey interruption information
F_{E} Journey interruption energy amount
F_{P} Journey interruption plan
P Parameter
tₙ Time

1. A method for operating a utility vehicle having an electric motor drive, an electrical storage system for supplying the electric motor drive and a fuel cell for supplying the electrical storage system, the method comprising:
controlling the fuel cell during a journey such that a charge level of the electric energy storage system is below a predetermined charge level when a journey interruption occurs; and,
continuing to control the fuel cell during the journey interruption until at least one of the electrical storage system has reached the predetermined charge level and the journey interruption has ended.

2. The method of claim 1 further comprising at least one of:
compiling or providing journey information on a forthcoming journey and journey interruption information on at least one journey interruption planned during the forthcoming journey; and,
determining a journey interruption energy amount that can be supplied from the fuel cell to the electrical storage system during the journey interruption.

3. The method of claim 2, wherein the fuel cell is controlled during the journey such that the charge level of the electrical storage system at a start of the journey interruption is below its predetermined charge state by at least the journey interruption energy amount.

4. The method of claim 2, wherein the journey information includes at least one of:
a length of the journey;
a duration of the journey;
a calendar information, in particular information about work days or days off;
a route topography;
a time interval from last completed journey;
a number of stops on the forthcoming journey; and,
a number of loading and unloading operations for freight on the utility vehicle.

5. The method of claim 2, wherein the journey interruption information includes at least one of:
a position on a route where the journey interruption occurs;
a start time of the journey interruption;
an end time of the journey interruption;
a duration of the journey interruption;
a time interval between adjacent journey interruptions; and,
a distance between adjacent journey interruptions.

6. The method of claim 2, wherein said compiling the journey interruption information includes:
determining a duration of a forthcoming journey;
determining a distance remaining after a next journey interruption;
determining a mass of freight loaded onto the vehicle;
determining information representative of a driving behavior of a driving staff;
determining the presence of a trailer attached to the utility vehicle for the forthcoming journey; and,
determining weather data for the duration of the forthcoming journey.

7. The method of claim 6, wherein at least one of:
an average energy consumption is determined; and,
weather data along a route is determined for the duration of the forthcoming journey.

8. The method of claim 6, wherein said compiling the journey interruption information includes at least one of:
determining a required journey interruption duration as a function of the determined journey duration;
compiling a journey interruption plan, in which the journey interruption duration is distributed over a number of journey interruptions throughout the duration of the journey; and,
at least one of modifying and confirming the compiled journey interruption plan via user input.

9. The method of claim 8, wherein the fuel cell is controlled as a function of the journey interruption plan.

10. The method of claim 1, wherein the fuel cell is configured to be operated at different operating points and the method further comprises:
adjusting an operating point of the fuel cell during the journey interruption depending on the journey interruption information.

11. The method of claim 1, wherein the fuel cell is configured to be operated at different operating points and the method further comprises:
adjusting an operating point of the fuel cell during the journey interruption depending on journey interruption information in dependence upon the duration of the journey interruption.

12. The method of claim 10, wherein the operating point of the fuel cell is adjusted such that the fuel cell continues to be controlled throughout an entirety of the journey interruption.

13. The method of claim 10, wherein the operating point of the fuel cell is adjusted such that the fuel cell continues to be controlled throughout an entirety of the journey interruption, in a range of at least one of 10% to 70% of the rated power of the fuel cell, 15% to 60% of the rated power of the fuel cell, and 20% to 50% of the rated power of the fuel cell.

14. The method of claim 1, wherein the fuel cell includes at least one compressor having a rotationally driven compressor shaft, the method further comprising:
continuing to drive the compressor shaft at a predetermined speed even if the predetermined charge level of the electrical storage system has been reached before the journey interruption has ended.

15. The method of claim 14, wherein the predetermined speed is above a lift-off speed.

16. The method of claim 1, wherein said controlling of the fuel cell during the journey is carried out such that a smaller amount of energy is provided, either continuously or in sections, during the journey than is requested by the electric motor drive of the utility vehicle, meaning that the remaining amount of energy required is supplied to the electric motor drive from the electrical storage system, resulting in a drop in the charge level.

17. The method of claim 16, wherein said controlling the fuel cell is executed during the journey such that a smaller amount of energy than that requested by the electric motor of the utility vehicle is provided in sections during the journey and wherein a point in time at which the fuel cell provides a smaller amount of energy is determined as a function of at least one parameter including at least one of:
a sought-after lower charge level threshold of the electrical storage system at the start of the journey interruption;
a falling below a predetermined travel time remaining until a next journey interruption;
a falling below a predetermined distance remaining until the next journey interruption; and,
a topography of the route remaining until the next journey interruption.

18. The method of claim 1, wherein the predetermined charge level of the electrical storage system is below the maximum charge capacity thereof.

19. The method of claim 1, wherein the predetermined charge level of the electrical storage system is below the maximum charge capacity thereof in a range of at least one of 50% to 80% and 60% to 70%.

20. A fuel cell system of a utility vehicle having an electric motor drive, the fuel cell system comprising:
an electrical storage system with a variable charge level for supplying the electric motor drive;
a fuel cell for supplying said electrical storage system;
a control unit connected to said fuel cell in a signal-conducting manner and being configured to control the fuel cell;
said control unit being configured to control said fuel cell during a journey such that a charge level of said electric energy storage system is below a predetermined charge level when a journey interruption occurs and to continue to control said fuel cell during the journey interruption until at least one of said electrical storage system has reached the predetermined charge level and the driving interruption has ended.

21. The fuel cell system of claim 20 further comprising:
at least one compressor having a compressor shaft configured to be driven rotationally; and,
said control unit being configured to continue to drive said compressor shaft at a predetermined speed even if the predetermined charge level of said electrical storage system has been reached, before the journey interruption has ended.

22. The fuel cell system of claim 21, wherein the predetermined speed is above a lift-off speed.

23. A control unit for a fuel cell system of a utility vehicle wherein the control unit is configured to execute the method of claim 1.

24. A computer program product containing commands which, when executed on a computer, cause the computer to form the control unit of claim 23.

25. A computer program product including commands which, when executed on a computer, perform the method of claim 1.
